(19) United States
(12) Patent Application Publication
(10) Pub. No.: US 2026/0246897 A1
(43) Pub. Date: Aug. 20, 2026

(54) INSTANT-ON AMBIENT VISUAL PROJECTION DEVICE

(71) Applicant: ZHONGSHAN BOLANG ELECTRONIC TECHNOLOGY CO., LTD., ZHONGSHAN CITY (CN)

(72) Inventors: GANG WANG, ZHONGSHAN CITY (CN); KE XIAN LIU, ZHONGSHAN CITY (CN)

(21) Appl. No.: 19/076,975

(22) Filed: Mar. 11, 2025

(30) Foreign Application Priority Data
Feb. 14, 2025 (CN) 202510171298.0

(51) Int. Cl. H04N 9/31; G03B 21/14

(52) U.S. Cl. CPC H04N 9/3155; G03B 21/142; G03B 21/145; H04N 9/3147; H04N 9/3152; H04N 9/3164

(57) ABSTRACT

Disclosed is an instant-on ambient visual projection device including: a first projection assembly including a display screen, a first light source serving as backlight of the display screen, and a first optical path unit guiding content to be played to form dynamic images projected into space; a second projection assembly including a second light source, and a second optical path unit guiding light therefrom to form ripple light patterns projected into space; a third projection assembly including a third light source, and a third optical path unit guiding light therefrom to form light diffraction patterns projected into space; and a controller configured to control operations of the first, second and third light sources and the playback of the display screen, and including a storage unit for storing the content to be displayed. This allows, upon startup, minimization of user interaction and waiting time while enhancing user experience.

### CROSS-REFERENCE TO RELATED PATENT APPLICATION

The present application claims the priority of Chinese Patent Application No. 202510171298.0, filed on Feb. 14, 2025, which is hereby incorporated by reference in its entirety.

### FIELD OF THE DISCLOSURE

The present disclosure relates to the field of ambient projection, and more particularly to instant-on ambient visual projection devices.

### BACKGROUND OF THE DISCLOSURE

Currently, ambient projection products predominantly rely on APP-based control or Wi-Fi connection to download projection content to the product terminal, thereby enabling the transition between product functions and scenes. Alternatively, the transition can be achieved by reading from an external storage device. A drawback of these methods is that, after the ambient projection products are powered on, they require users to actively initiate operations and wait for the products to establish an internet connection for downloading or read data from external sources, thereby adversely affecting user experience.

### SUMMARY OF THE DISCLOSURE

The present disclosure is directed to present an enhancement to current methods by providing an instant-on ambient visual projection device that incorporates a storage unit pre-loaded with projection content within a controller, thereby minimizing user interaction and waiting time upon startup while enhancing the user experience.

To accomplish the foregoing objectives, the technical solution adopted by the present disclosure is as follows.

An instant-on ambient visual projection device provided may include: a first projection assembly, a second projection assembly, a third projection assembly and a controller; wherein the first projection assembly comprises a display screen, a first light source and a first optical path unit, wherein the first light source serves as a backlight for the display screen, and a content displayed on the display screen, under a guidance of the first optical path unit, forms a dynamic image that is projected into space; the second projection assembly comprises a second light source and a second optical path unit, wherein a light emitted by the second light source, under a guidance of the second optical path unit, forms a ripple light pattern that is projected into space; the third projection assembly comprises a third light source and a third optical path unit, wherein a light emitted by the third light source, under a guidance of the third optical path unit, forms a light diffraction pattern that is projected into space; and the controller is configured to control operations of the first light source, the second light source and the third light source, and to control a playback of the display screen, wherein the controller comprises a storage unit for storing a content to be displayed on the display screen.

In some embodiments, the controller further comprises a power supply unit, a main control unit, a display control unit, a first light source drive unit, a second light source drive unit and a third light source drive unit; the power supply unit is configured to provide an appropriate power supply voltage for electronic components of said device; the main control unit is communicatively connected to the display control unit that is connected to the display screen and the storage unit; the display control unit is configured to control the playback of the display screen; the main control unit is connected to the first light source drive unit, the second light source drive unit and the third light source drive unit; the first light source drive unit is configured to drive the first light source; the second light source drive unit is configured to drive the second light source; and the third light source drive unit is configured to drive the third light source.

In some embodiments, the first light source comprises an LED array, the second light source comprises a multi-color LED, and the third light source comprises a green laser light.

In some embodiments, the first optical path unit comprises a light-condensing component, an optical lens and a plurality of lenses; and the first light source, the light-condensing component, the display screen and the optical lens are sequentially arranged along an optical path defined by the first optical path unit.

In some embodiments, the second optical path unit comprises a light-reflecting cup-like component and a light-condensing lens; the light-reflecting cup-like component is arranged above the second light source, the light-condensing lens is arranged above a top of the light-reflecting cup-like component, and an inner surface of the light-condensing lens is rippled; the third optical path unit comprises a light-transmitting aperture plate and a DOE grating, the light-transmitting aperture plate is arranged above the third light source, and the DOE grating is arranged above the light-transmitting aperture plate.

In some embodiments, the instant-on ambient visual projection device further comprises a motor and a transmission component, wherein the controller further comprises a motor drive unit that is connected to the main control unit and configured to drive the motor to rotate; and the motor drives the light-reflecting cup-like component, the light-transmitting aperture plate and the DOE grating to rotate synchronously via the transmission component.

In some embodiments, the instant-on ambient visual projection device further comprises an audio output component; wherein the controller further comprises an audio drive unit that is connected to the main control unit and is configured to drive the audio output component to play sound.

In some embodiments, the storage unit comprises a TF card socket, and a card sensing pin of the TF card socket is connected to a storage detection terminal of the main control unit.

In some embodiments, the instant-on ambient visual projection device further comprises a housing and a base, wherein the first projection assembly, the second projection assembly, the third projection assembly and the controller are arranged within the housing, two ends of the base are provided with support portions, both sides of the housing are rotatably connected to the support portions; and the controller further comprises an attitude detection unit for detecting a tilt angle of the housing.

In some embodiments, the controller further comprises a remote control signal receiving unit configured to receive remote control signals.

By implementing the aforementioned technical solution, the present disclosure achieves the following advantageous effects.

The instant-on ambient visual projection device according to the embodiments of the present disclosure controls the first projection assembly, the second projection assembly and the third projection assembly through the controller to simultaneously project dynamic images, ripple light patterns, and light diffraction patterns into space, providing users with a visual ambient viewing experience. In particular, the controller is equipped with a storage unit that stores the content to be displayed on the display screen, allowing users to enjoy said content immediately upon power-up, without needing an internet connection or manual setup, making it unnecessary to wait, and thereby significantly enhancing the user experience.

### BRIEF DESCRIPTION OF THE DRAWINGS

To more clearly illustrate the technical solutions in the embodiments of the present disclosure or in the prior art, the drawings required for the description of the embodiments or the prior art will be briefly introduced below. It is evident that the drawings described below are merely some embodiments of the present invention. For those skilled in the art, other drawings can be obtained based on these drawings without involving inventive effort.

FIG. 1 is a schematic view of the external structure of an instant-on ambient visual projection device in some embodiments;

FIG. 2 is a schematic view of the internal structure of an instant-on ambient visual projection device in some embodiments;

FIG. 3 is a plan view of the internal structure of an instant-on ambient visual projection device in some embodiments;

FIG. 4 is a bottom view of the internal structure of an instant-on ambient visual projection device in some embodiments;

FIG. 5 is a block diagram of electrical connections for a controller in some embodiments;

FIG. 6 is an electrical schematic diagram of a first voltage-reducing unit in some embodiments;

FIG. 7(a), a partially broken away left view, and FIG. 7(b) a partially broken away right view, collectively illustrate an electrical schematic diagram of a second voltage-reducing unit in some embodiments;

FIG. 8 is a partially shown electrical schematic diagram of a power supply unit in some embodiments;

FIG. 9 is a partially shown electrical schematic diagram of a power supply unit in some embodiments;

FIG. 10 is a schematic view of some pins of a chip in a display control unit in some embodiments;

FIG. 11 is a schematic view of the socket of a display screen socket in some embodiments;

FIG. 12(a), a partially broken away left view, and FIG. 12(b) a partially broken away right view, collectively illustrate an electrical schematic diagram of a main control unit in some embodiments;

FIG. 13 is an electrical schematic diagram of a first light source drive unit in some embodiments;

FIG. 14 is an electrical schematic diagram of a second light source drive unit in some embodiments;

FIG. 15 is an electrical schematic diagram of a third light source drive unit in some embodiments;

FIG. 16 is another block diagram of electrical connections for a controller in some embodiments;

FIG. 17 is an electrical schematic diagram of a motor drive unit in some embodiments;

FIG. 18 is an electrical schematic diagram of an audio drive unit in some embodiments; and

FIG. 19 is an electrical schematic diagram of a storage unit in some embodiments.

### DETAILED DESCRIPTION OF THE EXEMPLARY EMBODIMENTS

The following provides a detailed description of the present disclosure in conjunction with the accompanying drawings.

The embodiments disclosed herein merely serves as an illustration of the present disclosure and does not constitute a limitation thereof. Those skilled in the art may make modifications to the embodiments without making any inventive contributions after reading this specification. However, any such modifications will be protected by patent law as long as they fall within the scope of the claims of the present disclosure.

The present disclosure provides an instant-on ambient visual projection device that incorporates a storage unit pre-loaded with projection content within a controller, thereby minimizing user interaction and waiting time upon startup while enhancing the user experience.

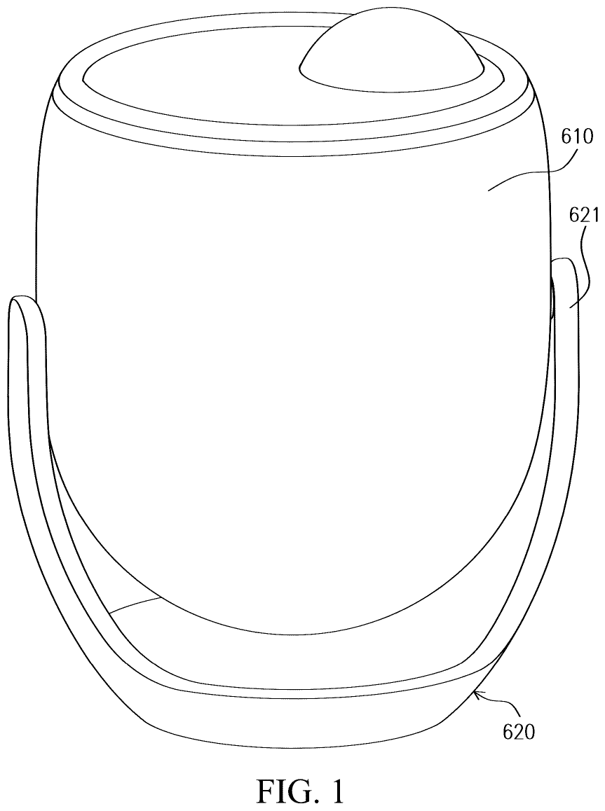

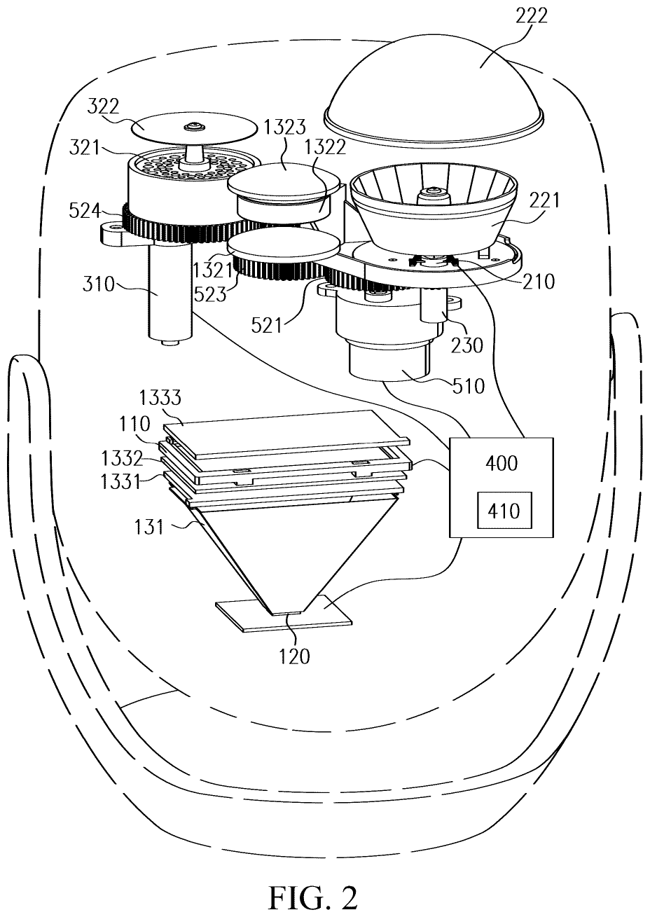

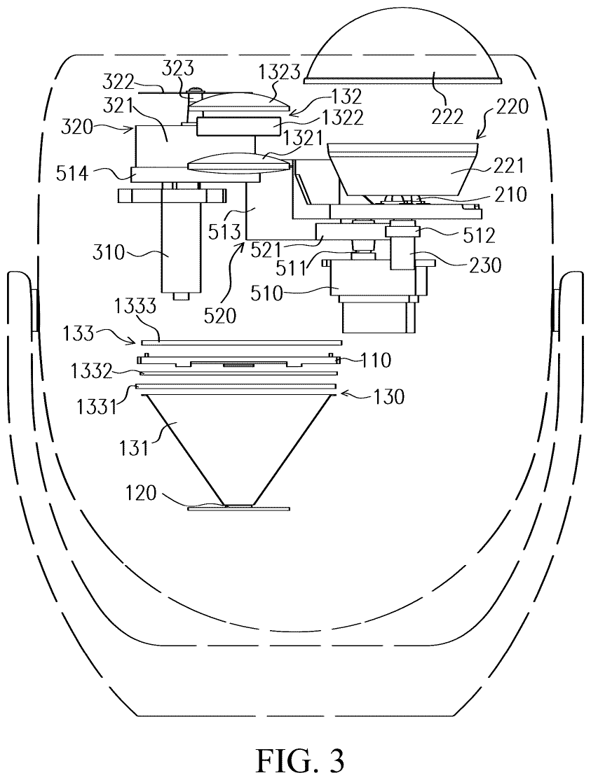

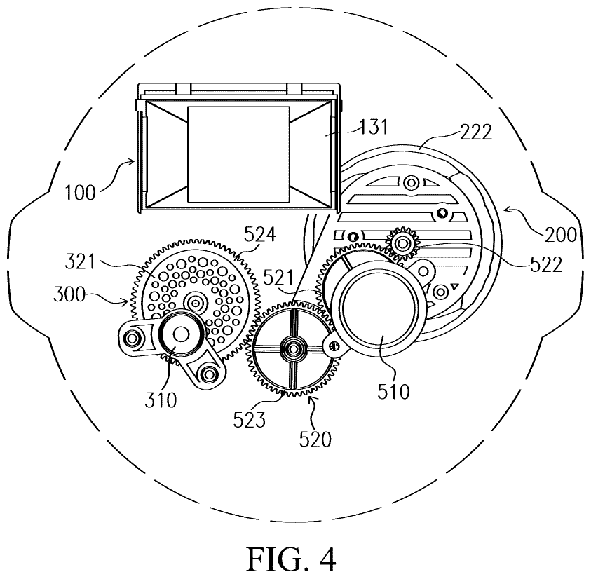

Referring to FIGS. 1 to 4, an instant-on ambient visual projection device in some embodiments comprises: a first projection assembly 100, a second projection assembly 200, a third projection assembly 300 and a controller 400. The first projection assembly 100 includes a display screen 110, a first light source 120 and a first optical path unit 130. The first light source 120 serves as the backlight for the display screen 110, and the content displayed on the display screen 110 is guided by the first optical path unit 130 to form a dynamic image that is projected into space. The second projection assembly 200 includes a second light source 210 and a second optical path unit 220. The light emitted from the second light source 210 is guided by the second optical path unit 220 to form a ripple light pattern that is projected into space. The third projection assembly 300 includes a third light source 310 and a third optical path unit 320. The light emitted from the third light source 310 is guided by the third optical path unit 320 to form a light diffraction pattern that is projected into space. The controller 400 is configured to control the illumination of the first light source 120, the second light source 210 and the third light source 310, as well as to control the playback of the display screen 110. The controller 400 further includes a storage unit 410 for storing the content to be played on the display screen 110.

The instant-on ambient visual projection device in the shown embodiments utilizes the controller 400 to simultaneously project dynamic images, ripple light patterns, and light diffraction patterns into space via the first projection assembly 100, the second projection assembly 200 and the third projection assembly 300, providing users with a visual ambiance viewing experience. Specifically, the controller 400 may incorporate a storage unit 410 for storing the content to be displayed on the display screen 110. Upon powering on the device, users can immediately enjoy the content without the need for internet connection or manual setup, eliminating any wait time and enhancing the overall user experience.

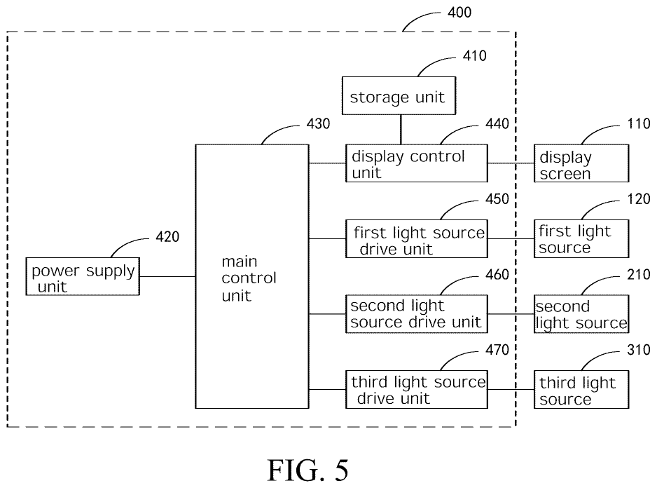

In some embodiments, referring to FIG. 5, the controller 400 further comprises a power supply unit 420, a main control unit 430, a display control unit 440, a first light source drive unit 450, a second light source drive unit 460 and a third light source drive unit 470. The power supply unit 420 is configured to provide a power supply voltage for the electronic components of the device. The main control unit 430 is communicatively connected to the display control unit 440, which is connected to the display screen 110 and the storage unit 410. The display control unit 440 is configured for controlling the playback of the display screen 110. The main control unit 430 is connected to the first light source drive unit 450, the second light source drive unit 460, and the third light source drive unit 470. The first light source drive unit 450 is configured to drive the first light source 120, the second light source drive unit 460 is configured to drive the second light source 210, and the third light source drive unit 470 is configured to drive the third light source 310.

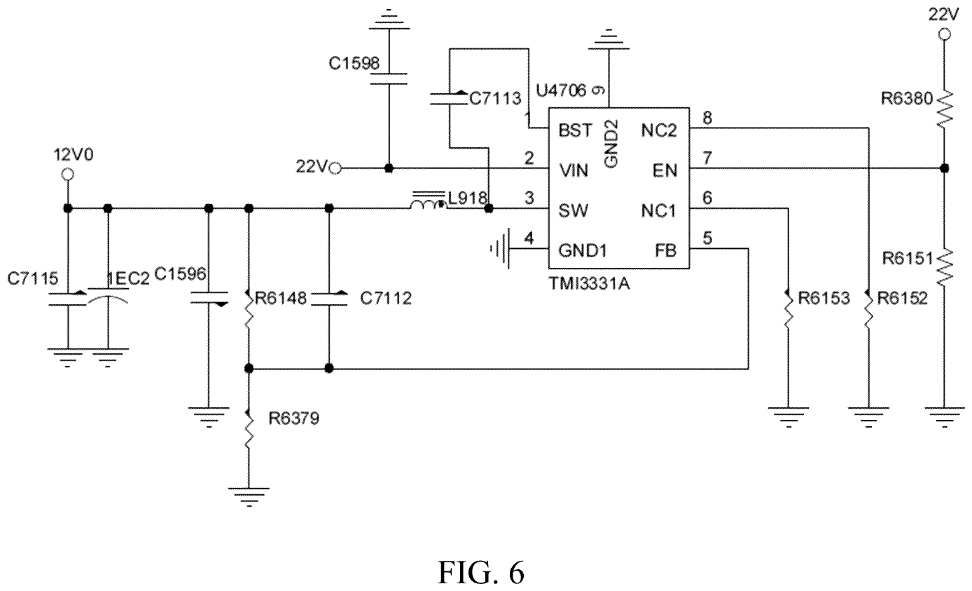

In some embodiments, referring to FIG. 6, the power supply unit 420 includes a first voltage-reducing unit configured to reduce the external 22V DC power supply to 12V DC power. The first voltage-reducing unit can be realized through a chip U4706, specifically the model TM13331A, along with its associated peripheral circuitry.

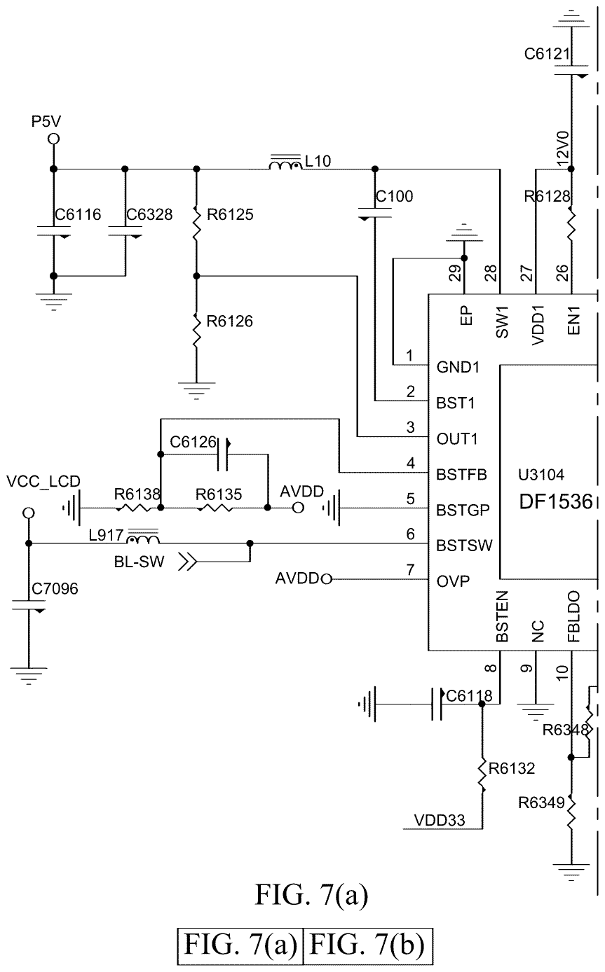

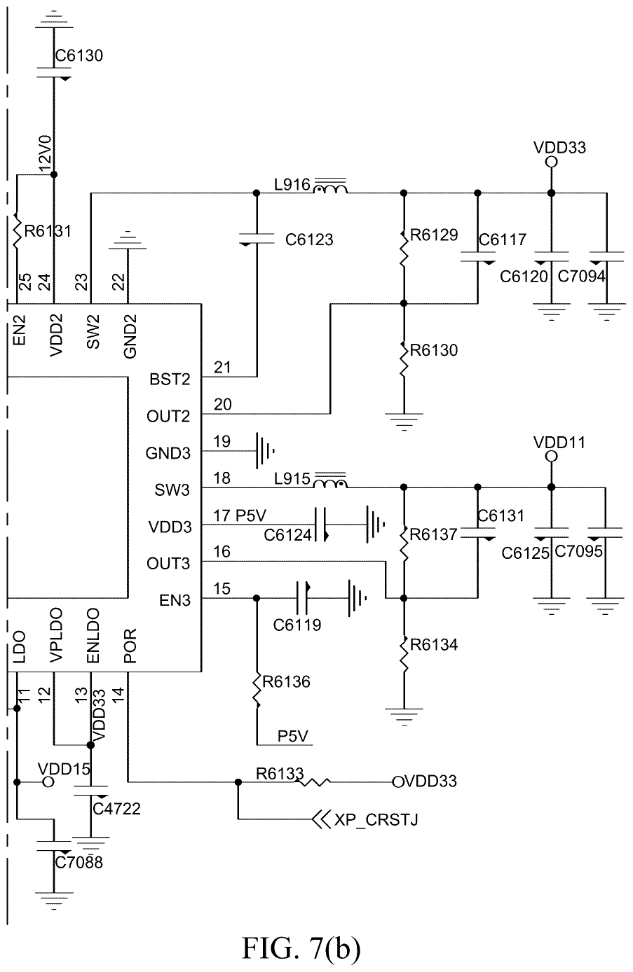

In some embodiments, referring to FIG. 7(a) and FIG. 7(b), the power supply unit 420 further includes a second voltage-reducing unit configured to convert a 12V DC power supply into a 5V DC power supply P5V, a 3.3V DC power supply VDD33, and a 1.1V DC power supply VDD11. The second voltage-reducing unit can be implemented through a chip U3104, specifically the model DF1536, along with its associated peripheral circuitry.

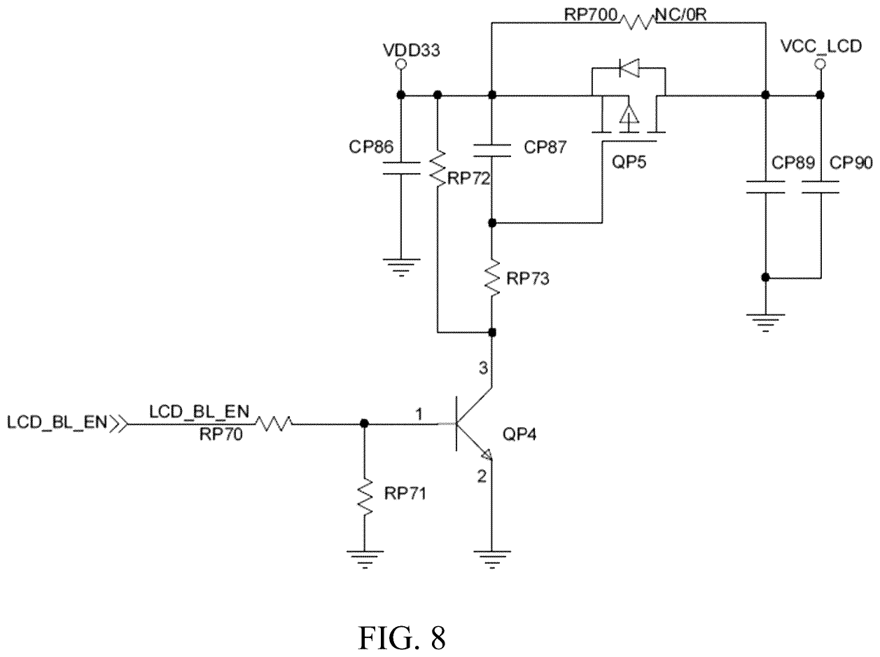

In some embodiments, referring to FIG. 8, the display power enable control terminal LCD_BL_EN of the display control unit 440 can be utilized to control the acquisition of the display screen's first power supply VCC_LCD from the 3.3V DC power supply VDD33. Alternatively, the display screen's first power supply VCC_LCD can be directly obtained from the 3.3V DC power supply VDD33.

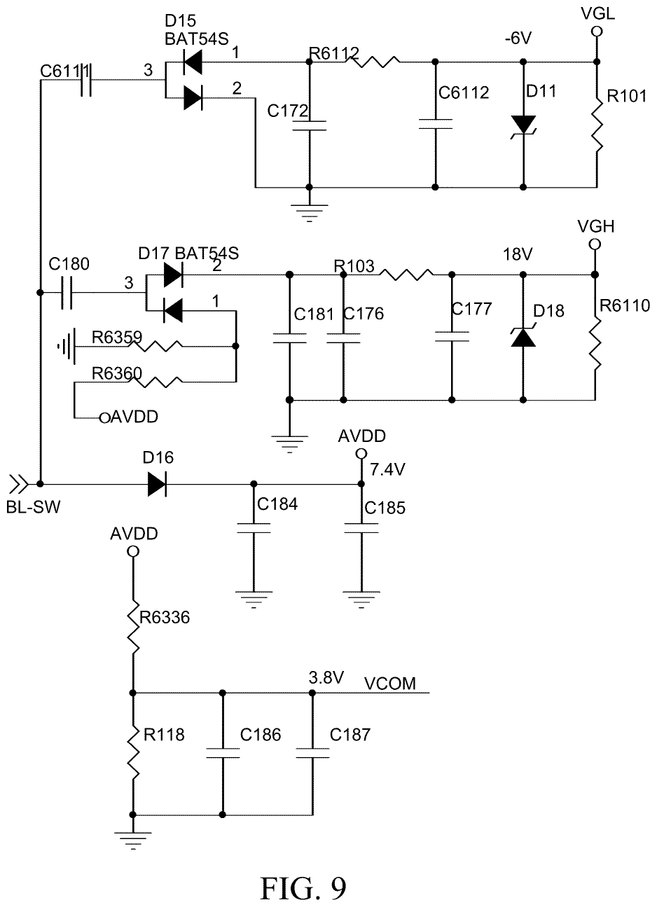

In some embodiments, referring to FIGS. 7 and 9, the power supply unit 420 can derive multiple power supplies of different voltage levels based on the display screen's first power supply VCC_LCD. Specifically, it can generate a-6V display screen second power supply VGL, a 18V display screen third power supply VGH, a 7.4V display screen fourth power supply AVDD and a 3.8V display screen fifth power supply VCOM.

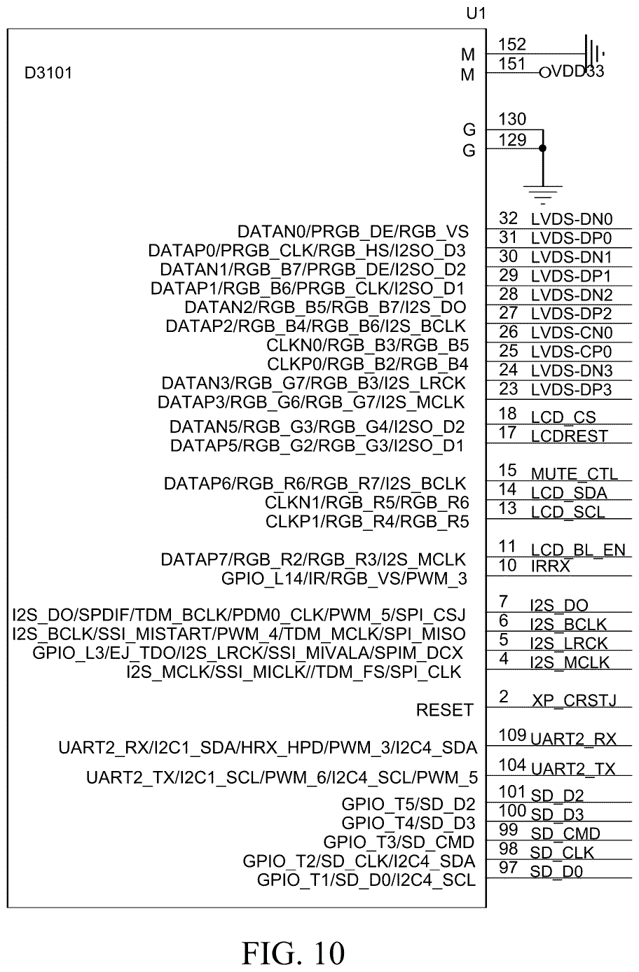

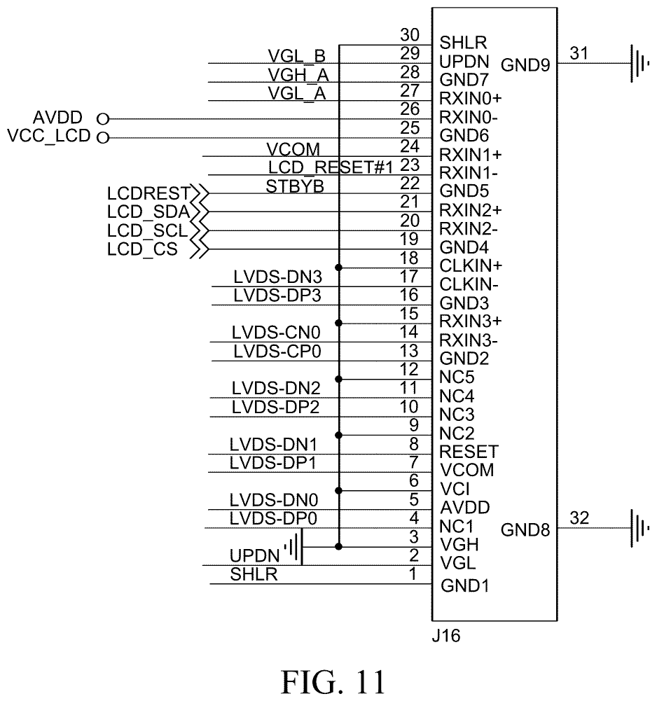

In some embodiments, referring to FIG. 10, the display control unit 440 can be implemented using a chip U1, specifically the model D3101, along with its associated peripheral circuitry. Referring to FIG. 11, the controller 400 connects to the display screen through a socket J16.

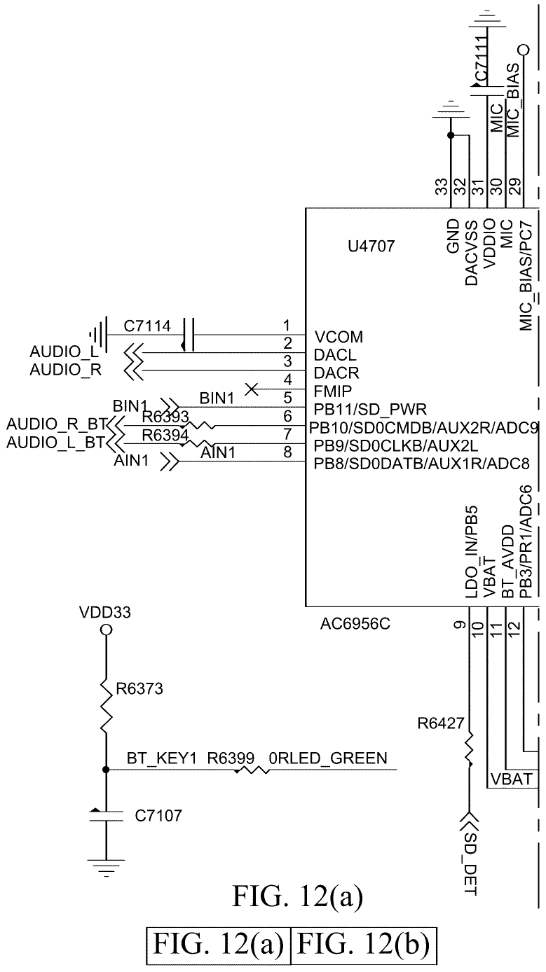

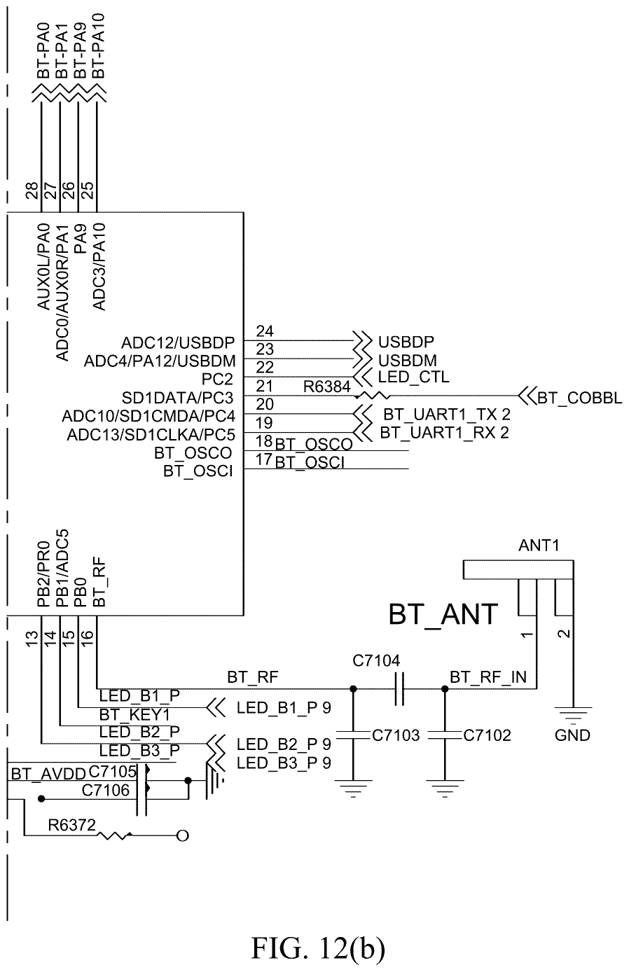

In some embodiments, referring to FIG. 12(a) and FIG. 12(b), the main control unit 430 can be implemented using a chip U4707, specifically the model AC6956C, along with its associated peripheral circuitry. The main control unit 430 connects to the display control unit 440 through a universal serial communication interface.

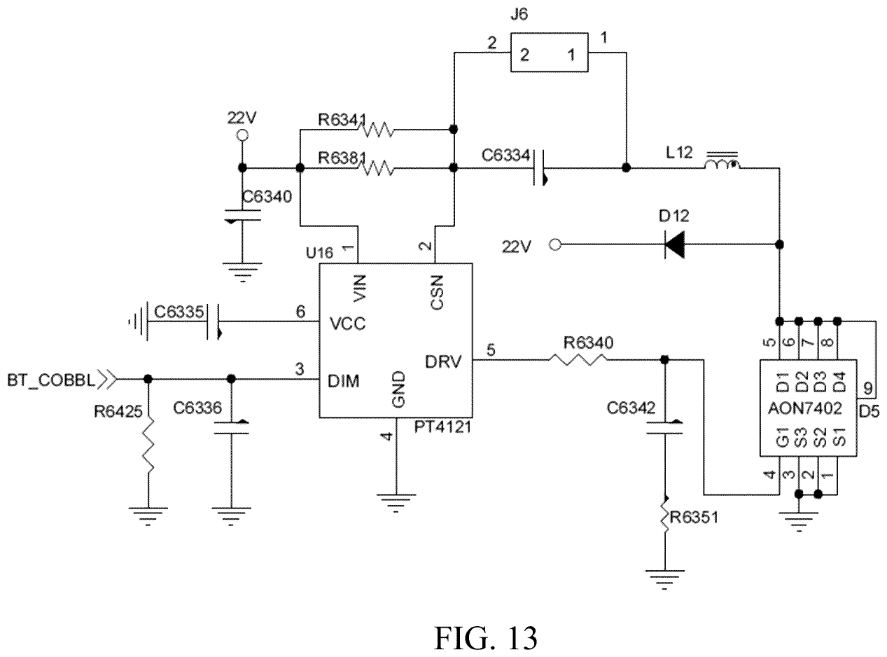

In some embodiments, referring to FIG. 13, the first light source drive unit 450 can be implemented using a chip U16, specifically the model PT4121, along with its associated peripheral circuitry. The first light source 120 is an LED array, accessed through the socket J6. The backlight control terminal BT_COBBL of the main control unit 430 connects to the DIM pin of the chip U16 to control the brightness of the first light source 120.

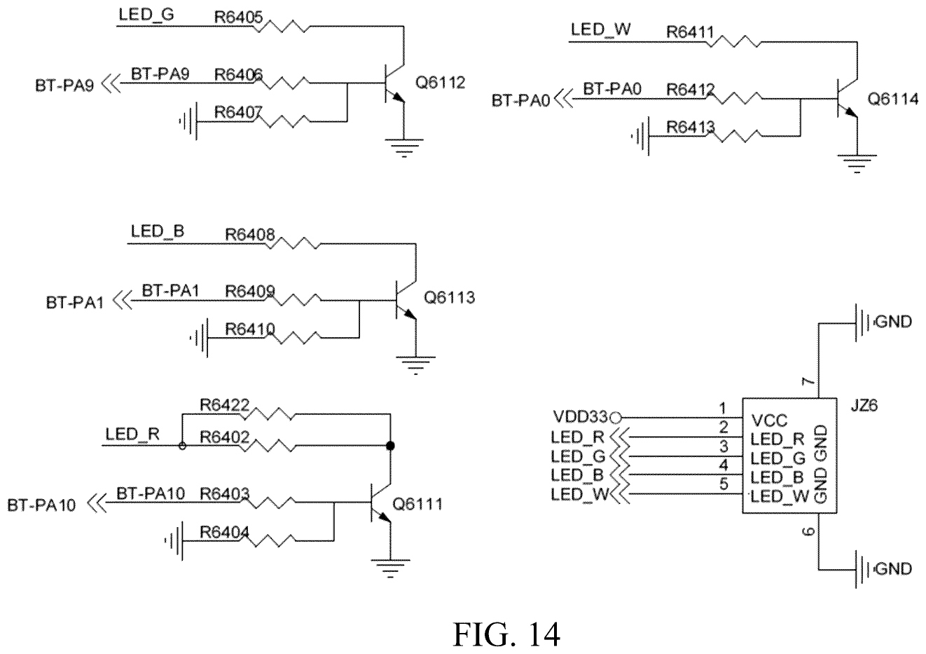

In some embodiments, referring to FIG. 14, the second light source 210 is a multi-color LED, accessed through a socket JZ6. The first light source drive unit 450 includes NPN transistors and a plurality of resistors, and controls the activation of the multi-color LED through the control terminals BT-PA9, BT-PA1, BT-PA10 and BT-PA0 of the main control unit 430.

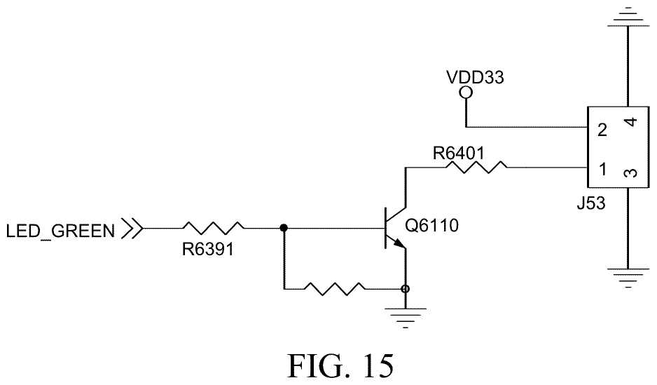

In some embodiments, referring to FIG. 15, the third light source 310 is a green laser light, accessed through a socket J53. The third light source drive unit 470 includes an NPN transistor Q6110 and a plurality of resistors, and controls the activation of the green laser light through the control terminal LED_GREEN of the main control unit 430.

In one embodiment, referring to FIGS. 1 to 4, the first optical path unit 130 comprises a light-condensing component 131, an optical lens 132 and a plurality of lenses 133. The first light source 120, the light-condensing component 131, the display screen 110 and the optical lens 132 are arranged in sequence along the optical path defined by the first optical path unit 130.

In some embodiments, the first light source 120 serves as the backlight for the display screen 110. The light emitted by the source 120, after being condensed by the light-condensing component 131, passes through the first lens 1331 and the second lens 1332 to illuminate the back side of the display screen 110. The image emanating from the front of the display screen 110 is adjusted and projected into the projection space through the third lens 1333 and the optical lens 132. The optical lens 132 may include a first convex lens 1321, a concave lens 1322 and a second convex lens 1323; and the distance between the lenses can be adjusted for focusing.

In some embodiments, referring to FIGS. 1 to 4, the second optical path unit 220 includes a light-reflecting cup-like component 221 (such as a reflector cup) and a light-condensing lens 222. The light-reflecting cup-like component 221 is arranged above the second light source 210, and the light-condensing lens 222 is arranged above the top of the light-reflecting cup-like component 221. The inner surface of the light-condensing lens 222 is textured with corrugations.

In some embodiments, the light emitted by the second light source 210 is reflected by the light-reflecting cup-like component 221 and illuminates the inner surface of the condensing lens 222. Then, it is scattered into the projection space through the light-condensing lens 222, forming a colorful corrugated light and shadow effect.

In some embodiments, referring to FIGS. 1 to 4, the third optical path unit 320 includes a light-transmitting aperture plate 321 and a DOE grating 322. The light-transmitting aperture plate 321 is arranged above the third light source 310, and the DOE grating 322 is arranged above the light-transmitting aperture plate 321.

In some embodiments, the light-transmitting aperture plate 321 is equipped with circular holes of different sizes. The laser emitted by the third light source 310 passes through the light-transmitting aperture plate 321 and then is diffracted through the DOE grating 322, resulting in a star sky pattern in the projection space.

In some embodiments, referring to FIGS. 1 to 4 and FIG. 16, the instant-on ambient visual projection device further comprises a motor 510 and a transmission component 520. The controller 400 also includes a motor drive unit 480 that is connected to the main control unit 430 and is used to drive the motor 510 to rotate. The motor 510 drives the light-reflecting cup-like component 221, the light-transmitting aperture plate 321, and the DOE grating 322 to rotate synchronously through the transmission component 520.

In some embodiments, the transmission component 520 specifically comprises: a motor gear 521 arranged on the motor rotation shaft 511, a first driven gear 522 and a transmission gear 523 arranged on the rotation shaft of the second optical path unit 230, and a second driven gear 524 arranged along the outer edge of the light-transmitting aperture plate 321. When the motor gear 521 rotates, it drives the first driven gear 522 and the transmission gear 523 to rotate together, which in turn drives the second driven gear 524 to rotate. The light-reflecting cup-like component 221 and the rotation shaft of the second optical path unit 230 are fixedly connected, when the first driven gear 522, the light-reflecting cup-like component 221 is rotated by the rotation shaft of the second optical path unit 230, forming a rotating colorful ripple light and shadow effect in the projection space. When the second driven gear 524 rotates, the light-transmitting aperture plate 321 is rotated, and through the connection shaft 323, the DOE grating 322 is rotated. This rotational motion can form rotating starry sky patterns in the projection space.

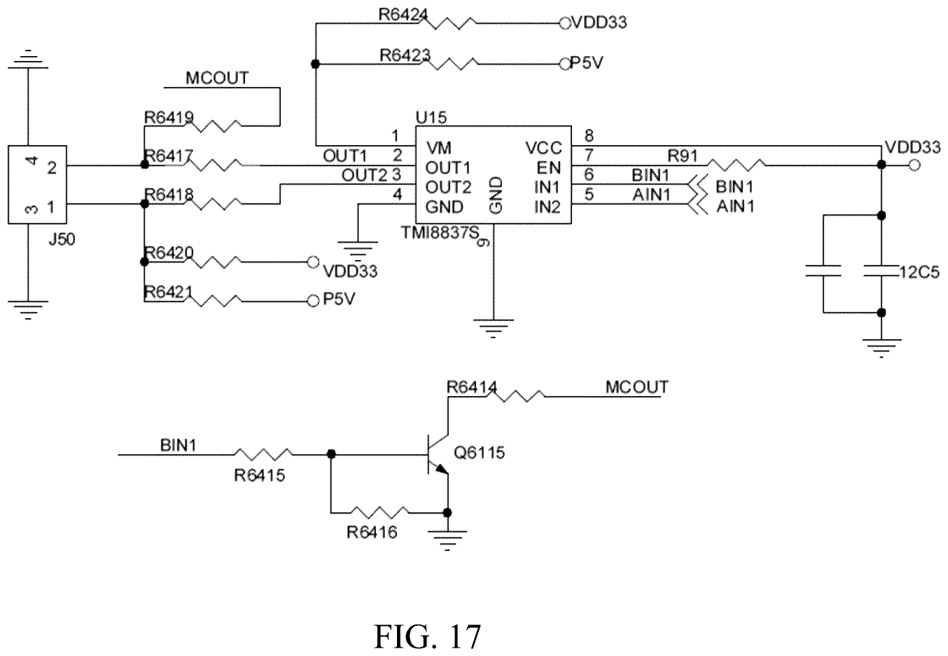

In some embodiments, referring to FIG. 17, the motor drive unit 480 can be implemented using a chip U15, specifically the model TMI8837S, along with its associated peripheral circuitry. The motor 510 is connected to the device via a socket J50, and controls the rotation of the motor 510 via the control terminals BIN1 and AIN1 of the main control unit 430.

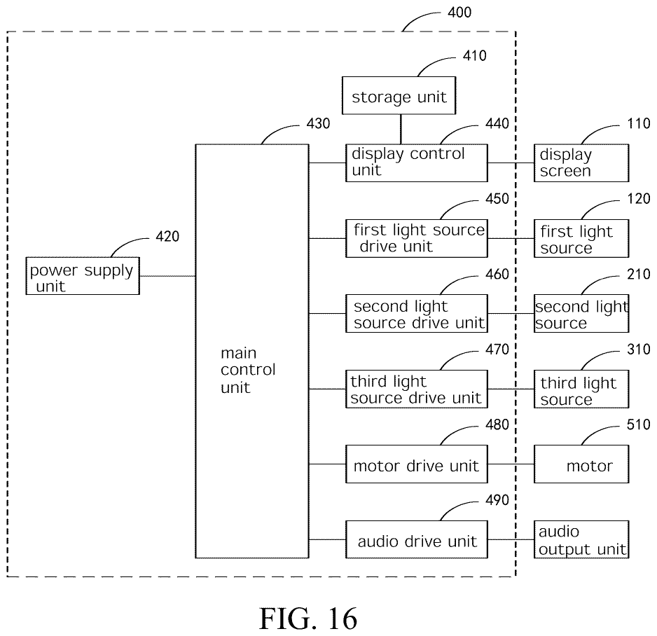

In one embodiment, referring to FIG. 16, the instant-on ambient visual projection device further comprises an audio output component such as a speaker (not shown in the figure). The controller 400 also includes an audio drive unit 490 that is connected to the main control unit 430 and is used to drive the audio output component to play sound.

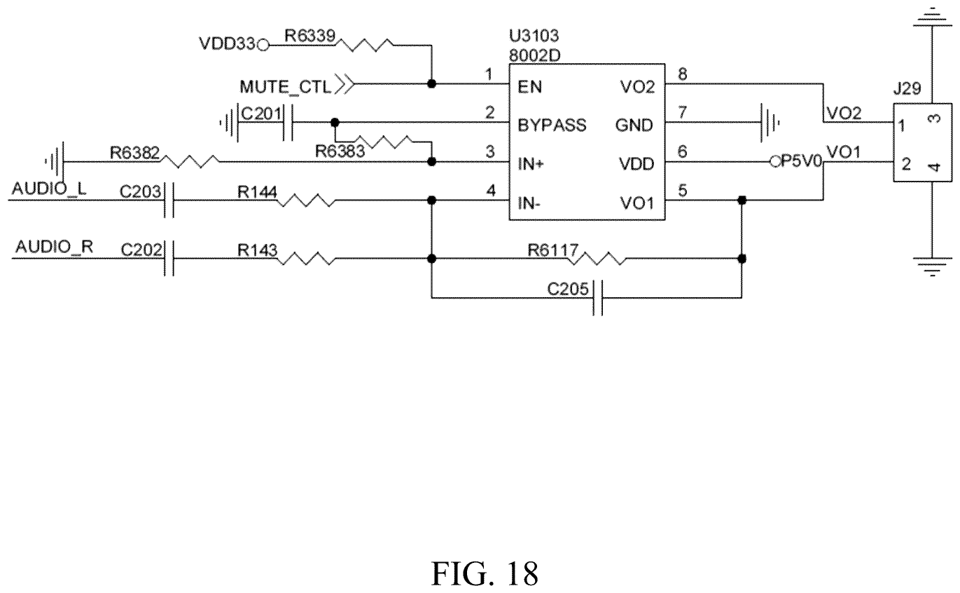

In some embodiments, referring to FIG. 18, the audio drive unit 490 can be implemented using a chip U3103, specifically the model 8002D, along with its peripheral circuitry. The audio output component is connected to the device via a socket J29, and the main control unit 430 outputs audio signals through signal terminals AUDIO_L and AUDIO_R. The main control unit 430 can acquire audio information to be played via Bluetooth or other wireless networks; alternatively or additionally, it can also communicate with the display control unit 440 to instruct it to read audio information from the storage unit 410.

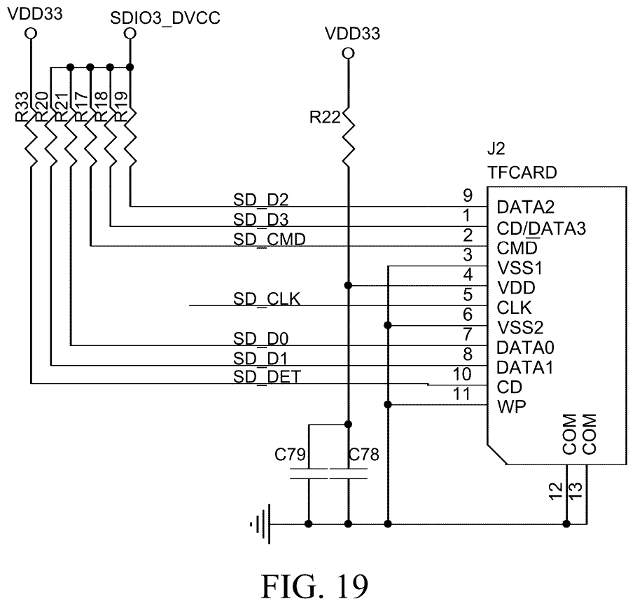

In one embodiment, as shown in FIG. 19, the storage unit 410 includes a TF card socket J2. The card sensing pin CD of the TF card socket J2 is connected to the storage detection terminal SD_DET of the main control unit 430. The storage unit 410 can store data using a TF card, and the main control unit 430 can detect the presence of a TF card in the TF card socket J2 through the storage detection terminal SD_DET.

In some embodiments, as shown in FIGS. 1 to 4, the device further comprises a housing 610 and a base 620. The first projection assembly 100, the second projection assembly 200, the third projection assembly 300, and the controller 400 are all arranged within the housing 610. The base 620 includes support portions 621 at both ends, and both sides of the housing 610 are rotatably connected to the support portions 621. The controller 400 further comprises an attitude detection unit (such as a tilt angle sensor), which is used to detect the inclination angle of the housing 610.

In some embodiments, the attitude detection unit may be a three-axis accelerometer sensor and can be communicatively connected to the display control unit 440. The display control unit 440 can obtain the inclination angle of the housing 610 through the attitude detection unit, thereby adjusting the playback of the video content. For example, it controls the video content to be played upright or inverted.

In some embodiments, the controller 400 further includes a remote control signal receiving unit that is used to receive remote control signals. In some embodiments, the remote control signal receiving unit may include an infrared photodiode for receiving remote control signals in the form of infrared light.

The above is intended to illustrate the inventive concept of the present disclosure and is not intended to limit it. Modifications or equivalent substitutions made to the inventive concept by those skilled in the art should be covered within the scope of the claims of the present disclosure, provided they do not depart from the spirit and scope of the inventive concept.

What is claimed is:

1. An instant-on ambient visual projection device, comprising: a first projection assembly, a second projection assembly, a third projection assembly and a controller;
wherein the first projection assembly comprises a display screen, a first light source and a first optical path unit, wherein the first light source serves as a backlight for the display screen, and a content displayed on the display screen, under a guidance of the first optical path unit, forms a dynamic image that is projected into space;
the second projection assembly comprises a second light source and a second optical path unit, wherein a light emitted by the second light source, under a guidance of the second optical path unit, forms a ripple light pattern that is projected into space;
the third projection assembly comprises a third light source and a third optical path unit, wherein a light emitted by the third light source, under a guidance of the third optical path unit, forms a light diffraction pattern that is projected into space; and
the controller is configured to control operations of the first light source, the second light source and the third light source, and to control a playback of the display screen, wherein the controller comprises a storage unit for storing a content to be displayed on the display screen.

2. The instant-on ambient visual projection device according to claim 1, wherein the controller further comprises a power supply unit, a main control unit, a display control unit, a first light source drive unit, a second light source drive unit and a third light source drive unit; the power supply unit is configured to provide an appropriate power supply voltage for electronic components of said device; the main control unit is communicatively connected to the display control unit that is connected to the display screen and the storage unit; the display control unit is configured to control the playback of the display screen; the main control unit is connected to the first light source drive unit, the second light source drive unit and the third light source drive unit; the first light source drive unit is configured to drive the first light source; the second light source drive unit is configured to drive the second light source; and the third light source drive unit is configured to drive the third light source.

3. The instant-on ambient visual projection device according to claim 2, wherein the first light source comprises an LED array, the second light source comprises a multi-color LED, and the third light source comprises a green laser light.

4. The instant-on ambient visual projection device according to claim 1, wherein the first optical path unit comprises a light-condensing component, an optical lens and a plurality of lenses; and the first light source, the light-condensing component, the display screen and the optical lens are sequentially arranged along an optical path defined by the first optical path unit.

5. The instant-on ambient visual projection device according to claim 3, wherein the second optical path unit comprises a light-reflecting cup-like component and a light-condensing lens; the light-reflecting cup-like component is arranged above the second light source, the light-condensing lens is arranged above a top of the light-reflecting cup-like component, and an inner surface of the light-condensing lens is rippled;
the third optical path unit comprises a light-transmitting aperture plate and a DOE grating, the light-transmitting aperture plate is arranged above the third light source, and the DOE grating is arranged above the light-transmitting aperture plate.

6. The instant-on ambient visual projection device according to claim 5, further comprising a motor and a transmission component, wherein the controller further comprises a motor drive unit that is connected to the main control unit and configured to drive the motor to rotate; and the motor drives the light-reflecting cup-like component, the light-transmitting aperture plate and the DOE grating to rotate synchronously via the transmission component.

7. The instant-on ambient visual projection device according to claim 6, further comprising an audio output component; wherein the controller further comprises an audio drive unit that is connected to the main control unit and is configured to drive the audio output component to play sound.

8. The instant-on ambient visual projection device according to claim 2, wherein the storage unit comprises a TF card socket, and a card sensing pin of the TF card socket is connected to a storage detection terminal of the main control unit.

9. The instant-on ambient visual projection device according to claim 1, further comprising a housing and a base, wherein the first projection assembly, the second projection assembly, the third projection assembly and the controller are arranged within the housing, two ends of the base are provided with support portions, both sides of the housing are rotatably connected to the support portions; and the controller further comprises an attitude detection unit for detecting a tilt angle of the housing.

10. The instant-on ambient visual projection device according to claim 1, wherein the controller further comprises a remote control signal receiving unit configured to receive remote control signals.
